(19) United States
(12) Patent Application Publication
(10) Pub. No.: US 2024/0113312 A1
(43) Pub. Date: Apr. 4, 2024

(54) FUEL CELL SYSTEM AND METHOD FOR DRAINING CONDENSATE WATER THEREOF

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/464,442

(22) Filed: Sep. 11, 2023

(30) Foreign Application Priority Data
Oct. 4, 2022 (KR) 10-2022-0126110

(51) Int. Cl. H01M 8/04119; H01M 8/04492; H01M 8/04746

(52) U.S. Cl. CPC H01M 8/04164; H01M 8/04492; H01M 8/04753; H01M 2250/20

(57) ABSTRACT

A fuel cell system including a drain valve configured to adjust an amount of condensate water being drained, at an outlet of a water trap having the condensate water drained from an anode of a fuel cell stack and a controller configured to control the drain valve to be open or closed, based on a water level of the condensate water stored in the water trap and control the drain valve to be open or closed at a specific period, when a body of the fuel cell system is tilted.

### CROSS-REFERENCE TO RELATED APPLICATION

This application claims the benefit under 35 USC § 119(a) of Korean Patent Application No. 10-2022-0126110, filed in the Korean Intellectual Property Office on Oct. 4, 2022, the entire disclosure of which is incorporated herein by reference for all purposes.

### BACKGROUND

### 1. Field

The present disclosure relates to a fuel cell system and a method for draining condensate water thereof.

### 2. Description of the Related Art

A fuel cell system may generate electrical energy using a fuel cell stack. For example, when hydrogen is used as the fuel of a fuel cell stack, hydrogen may be an alternative for a global environment problem. Accordingly, studies and researches for the fuel cell system have been consecutively performed.

The fuel cell system includes a fuel cell stack which generates electrical energy, a fuel supply which supplies fuel (hydrogen) to the fuel cell stack, an air supply which supplies oxygen in the air serving as an oxidant necessary for electrochemical reactions, and a thermal management system (TMS) which removes reaction heat from the fuel cell stack to discharge the reaction heat of the fuel cell stack to the outside of the system, controls an operating temperature of the fuel cell stack, and performs a water managing function.

The fuel cell system makes reaction between hydrogen, which serves as fuel, and oxygen in the air in a fuel cell stack to generate electricity and to exhaust heat and water serving reaction by-products. In this case, the fuel cell system condenses water and stores the condensate water in a water trap at an anode, senses a water level of the condensate water through a water-level sensor, opens a valve when the condensate water is condensed at a specific water level or more to drain the condensate water stored in the water trap.

Recently, the fuel cell system has been applied to various moving objects such as a flying object as well as a vehicle. The flying object is tilted with respect to three axes (an X axis, a Y axis, and a Z axis) when moving, and the condensate water store in the water trap is tilted due to the tilt of the body.

In the fuel cell system to open a drain valve and drain the condensate water when the condensate water reaches the specific water level, and when the condensate water stored in the water trap is tilted in a direction opposite to a water-level sensor as the fling object is moved, the condensate water does not reach the water-level sensor, so the exact water level of the condensate water is not sensed. Accordingly, the condensate water reaches an inlet of the water trap and overflowed.

In addition, since the flying object flies on the sky, the condensate water stored in the water trap may be frozen due to the temperature decreased with higher height. In particular, when an ambient temperature is lower like in winter, and when the flying object flies on the sky with condensate water stored in the water trap, the condensate water stored in the water trap is frozen, it is difficult to drain the condensate water through the control of the drain valve, and the weight of the flying object in flying is increased due to the frozen condensate water, thereby degrading the driving efficiency of the fuel cell system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a fuel cell system including a drain valve configured to adjust an amount of condensate water being drained, at an outlet of a water trap having the condensate water drained from an anode of a fuel cell stack and a controller configured to control the drain valve to be open or closed, based on a water level of the condensate water stored in the water trap and control the drain valve to be open or closed at a specific period, when a body of the fuel cell system is tilted.

The fuel cell system may include a plurality of acceleration sensors provided at different positions of the body of the fuel cell system.

The controller may be configured to determine a tilting state of the body of the fuel cell system, based on measurement values measured by one or more of the plurality of acceleration sensors.

The plurality of acceleration sensors may include a first acceleration sensor provided on a front surface of the body of the fuel cell system, a second acceleration sensor provided on a right surface of the body of the fuel cell system, a third acceleration sensor provided on a rear surface of the body of the fuel cell system, and a fourth acceleration sensor provided on a left surface of the body of the fuel cell system.

The controller may be configured to estimate a tilting angle and a flying speed of the body of the fuel cell system by defining a reference position based on a measurement value measured by the first acceleration sensor and determining acceleration values for an X axis, a Y axis, and a Z axis based on respective measurement values measured by the second to fourth acceleration sensors.

The controller may be configured to control an opening operation and a closing operation of the drain valve at the specific period, when the tilting angle or the flying speed is equal to or greater than a reference value.

The controller may be configured to switch a drain path of the condensate water to a by-pass line, based on one or more of an external temperature and an atmospheric pressure.

The fuel cell system may include a first by-pass valve provided at an inlet of the water trap to by-pass, to a by-pass line, a flowing path of the condensate water flowing into the water trap and a second by-pass valve connected to an outlet of the drain valve and the by-pass line to determine a drain path of the condensate water.

The controller may be configured to open the first by-pass valve and close the second by-pass valve to switch the drain path of the condensate water to the by-pass line, when the external temperature is equal to or less than a specific temperature and when the atmospheric pressure is equal to or less than specific atmospheric pressure.

The controller may be configured to open the drain valve until a water level of condensate water stored in the water trap reaches a preset low level, before the drain path of the condensate water is switched to the by-pass line and close the drain valve when the water level of the condensate water reaches the preset low level.

The controller may be configured to close the first by-pass valve and open the second by-pass valve when the condensate water is drained to the water trap.

In a general aspect, here is provided a method for draining condensate water of a fuel cell system including controlling a drain valve, which is provided at an outlet of a water trap, to be open or closed, based on a water level of the condensate water stored in the water trap having the condensate water drained from an anode of a fuel cell stack and controlling the drain valve to be open or closed at a specific period of time when a body of the fuel cell system is tilted.

The method may include determining a tilting state of the body of the fuel cell system, based on measurement values measured by a plurality of acceleration sensors provided at different positions of the body of the fuel cell system.

The determining of the tilting state of the body of the fuel cell system may include estimating a tilting angle and a flying speed of the body of the fuel cell system by defining a reference position based on a measurement value measured by a first acceleration sensor and determining acceleration values for an X axis, a Y axis, and a Z axis based on measurement values measured by second, third, and fourth acceleration sensors.

The controlling of the drain valve to be open or closed at the specific period may includes controlling an opening operation and a closing operation of the drain valve at the specific period, when the tilting angle or the flying speed is equal to or greater than a reference value.

The first acceleration sensor may be provided on a front surface of the body of the fuel cell system, and the second, third, and fourth acceleration sensors may be respectively provided on a right surface, a rear surface, and a left surface of the body of the fuel cell system.

The method may include switching a drain path of the condensate water to a by-pass line based on an external temperature and atmospheric pressure.

The switching into the by-pass line may include opening a first by-pass valve, the first by-pass valve being provided at an inlet of the water trap to by-pass, to a by-pass line, to cause a flowing path of the condensate water flowing into the water trap and closing a second by-pass valve, the second by-pass valve being connected to an outlet of the drain valve and the by-pass line to establish a drain path of the condensate water when the external temperature is equal to or less than a specific temperature, and when the atmospheric pressure is equal to or less than specific atmospheric pressure.

The method may include opening the drain valve until a water level of condensate water stored in the water trap reaches preset low level, before switching to the by-pass line and closing the drain valve when the water level of the condensate water reaches the low level.

The method may include closing the first by-pass valve and opening the second by-pass valve, such that the condensate water is drained to the water trap before switching to the by-pass line.

### BRIEF DESCRIPTION OF THE DRAWINGS

FIG. 1 is a view illustrating a fuel cell system, according to an embodiment of the present disclosure;

FIG. 2 is a view illustrating a control structure of a fuel cell system, according to an embodiment of the present disclosure;

FIG. 3 is a view illustrating an arrangement structure of an acceleration sensor, according to an embodiment of the present disclosure;

FIGS. 4A and 4B are views illustrating an operation of draining condensate water in a fuel cell system, according to an embodiment of the present disclosure;

FIGS. 5A and 5B are views illustrating an operation of draining condensate water in a fuel cell system, according to another embodiment of the present disclosure; and

FIG. 6 is a flowchart illustrating the operation in a method of draining condensate water in an acceleration sensor, according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

A fuel cell system according to the present disclosure is applicable to a flying object flying in the air. In the following description of embodiments, although it is illustrated that the fuel cell system is provided at a lower portion of the flying object, the placement position and the size of the fuel cell system illustrated in the drawing are provided only for the convenience of explanation. For example, the fuel cell system may be provided inside or outside the flying object, and the size of the fuel cell system may be adjustable.

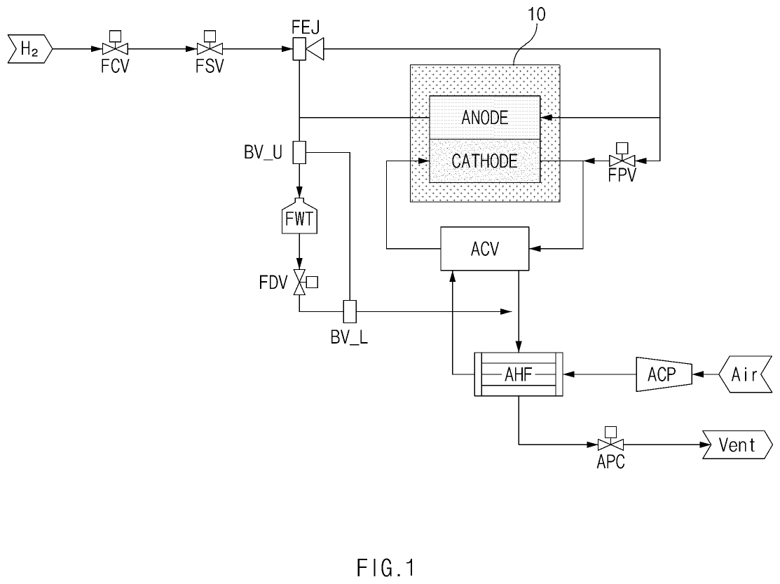

FIG. 1 is a view illustrating a fuel cell system, according to an embodiment of the present disclosure.

Referring to FIG. 1, the fuel cell system may include a fuel cell stack 10, and may further include a hydrogen supply line connected to an anode of the fuel cell stack 10 to allow hydrogen to move and be supplied to the fuel cell stack 10, an air supply line connected to a cathode of the fuel cell stack 10 to move air to be supplied to the fuel cell stack 10, and an exhaust line and a purge line for exhaust moisture (water), which is a by-product of a reaction, or a non-reacted gas, to the outside.

The fuel cell stack 10 (or may be referred to as a ‘fuel cell’) may be formed in a structure for generating electricity through an oxidation-reduction reaction between fuel (e.g., hydrogen) and an oxidizing agent (e.g., air). For example, the fuel cell stack 10 may be a polymer electrolyte membrane fuel cell (PEMFC).

The fuel cell stack 10 may include a membrane electrode assembly (MEA) having catalyst electrode layers attached to opposite sides of an electrolyte membrane for transferring hydrogen ions, a gas diffusion layer (GDL) to uniformly distribute reaction gases and transfer the generated electrical energy, a gasket and clamping mechanism to maintain airtightness and proper clamping pressure of reaction gases and cooling water a bipolar plate to transfer the reaction gases and the cooling water.

In the fuel cell stack 10, the hydrogen serving as fuel and the air (oxygen) serving as the oxidizing agent may be supplied to an anode and a cathode of the MEA through a fluid passage of the bipolar plate. For example, the hydrogen may be supplied to the anode serving as a hydrogen electrode and the air may be supplied to the cathode serving as an air electrode.

The hydrogen, which is supplied to the anode, is decomposed into a proton and an electron through catalysts provided at opposite sides of an electrolyte film. Among them, only a hydrogen ion selectively passes through the electrolyte film, which is a cation exchange membrane, and is transmitted to the cathode while the electron is transmitted to the cathode through a gas diffusion layer and the bipolar plate. In the cathode, the hydrogen ions supplied through the electrolyte membrane and the electrons received through the bipolar plate meet oxygen of the air supplied to the cathode through an air supply device, thereby generating water. In this case, the electrons may flow through an external conductive line due to the transfer of the hydrogen ions, and the flow of the electrons may generate a current.

A fuel cut-off Valve (FCV), a fuel supply valve (FSV), and a fuel ejector (FEJ) may be disposed on a hydrogen supply line. The hydrogen supply line may be connected to a hydrogen tank.

The FCV may be interposed between the hydrogen tank and the FSV on the hydrogen supply line to cut off the supply of the hydrogen exhausted from the hydrogen tank to the fuel cell stack. The FCV may be controlled to be open in a start-On state of the fuel cell system, and controlled to be closed in a start-Off state of the fuel cell system.

The FSV may be interposed between the FCV and the FFJ on the hydrogen supply line to adjust the pressure of hydrogen supplied from the fuel cell stack 10. For example, when the pressure of the hydrogen supply line is reduced, the FSV may be controlled to be open to supply hydrogen. When the pressure of the hydrogen supply line is increased, the FSV may be controlled to be closed.

The FEJ may be interposed between the FSV and the fuel cell stack 10 on the hydrogen supply line to apply pressure to the hydrogen output from the FSV such that the hydrogen is supplied to the fuel cell stack 10.

The hydrogen supply line may link an outlet of the fuel cell stack 10 to the FEJ to form a circulation loop of the hydrogen. Accordingly, the hydrogen drained from the hydrogen ejector (FEJ) reacts with the air in the fuel cell stack 10 to generate electrical energy, and non-reacted hydrogen may be drained through the outlet of the fuel cell stack 10 and re-introduced into the hydrogen ejector (FEJ). In this case, the non-reacted hydrogen may be re-introduced into the hydrogen ejector (FEJ) and supplied to the fuel cell stack again, thereby increasing the reaction efficiency of the hydrogen.

The air and the water remaining after reaction in the fuel cell stack 10 may be drained through a drain line. In this case, the drain line may include a first drain line extending from an outlet of the anode of the fuel cell stack 10 to an AHF, a second drain line extending from an outlet of the cathode of the fuel cell stack 10 to the AHF through an air cut-off valve (ACV), and a third drain line connected to the outside through an air pressure control valve (APC) from the AHF.

Meanwhile, the purge line may be linked to one point on the hydrogen supply to transfer hydrogen, which is supplied from the FEJ to the anode of the fuel cell stack 10, and a fuel-line purge valve (FPV) may be disposed on the purge line.

The fuel-line purge valve (FPV) is a valve open and closed to manage hydrogen concentrations in the fuel cell stack 10 and the hydrogen supply line to be maintained in a specific range.

The fuel cell stack 10 may generate electrical energy by using hydrogen and air. While the fuel cell stack 10 is driven in a normal state, the fuel-line purge valve (FPV) is closed.

In this case, the air supplied to the fuel cell stack 10 includes nitrogen in addition to oxygen, and crossover is caused to reduce the cell voltage due to the difference in nitrogen partial pressure between the anode and the cathode. Accordingly, the fuel-line purge valve (FPV) increases the hydrogen concentration in the anode by draining the residual hydrogen to decrease a nitrogen concentration, such that stack performance is maintained. The fuel-line purge valve (FPV) may be controlled to be open to purge hydrogen, such that the hydrogen concentration in the anode is maintained to be a specific amount or more, when an accumulated current calculated by integrating a current generated during a specific period exceeds a target value in the fuel cell stack 10.

The ACP, the AHF, and the ACV may be provided on an air supply line.

The air compressor (ACP) may be interposed between an air inlet, which sucks ambient air, and the AHF on the air supply line to suck and compress the ambient air and to supply the compressed air.

The AHF may be interposed between the ACP and the FCV on the air supply line to adjust the humidity of the air sucked and compressed by the ACP such that the compressed air is supplied to the cathode of the fuel cell stack 10. The AHF supplies moisture to the introduced air to adjust humidity, when the air compressed by the ACP is introduced into an inlet through an inlet of the AHF. For example, the AHF may humidify air supplied from the air compressor (ACP) using condensate water introduced through a first drain line linking the anode of the fuel cell stack 10 to the AHF, and moisture included in air drained through a second drain line linking the cathode of the fuel cell stack 10 to the AHF.

The AHF may be linked to a hydrogen outlet of the fuel cell stack 10 through the first drain line and may supply moisture to the air supplied from the air compressor (ACP) using the condensate water introduced through the first drain line.

In addition, the AHF may be connected to the air outlet of the fuel cell stack 10 through the second drain line, and air drained from the cathode of the fuel cell stack 10 may flow into the AHF through the second drain line. Here, since air drained from the cathode of the fuel cell stack 10 contains moisture, the AHF may apply moisture by exchanging moisture between the air drained from the cathode of the fuel cell stack 10 and the air supplied from the air compressor (ACP). As described above, the air having moisture supplied by the AHF flows into the cathode of the fuel cell stack 10 to generate water after reacting with hydrogen.

Meanwhile, the humidifier (AHF) is connected to an external outlet through a third drain line and discharges air, which is introduced through the second drain line, to the outside through the third drain line. In this case, an air pressure control valve (APC) may be disposed on a third drain line. A fluid passage may be formed on a rear end of the APC to drain the condensate water. The fluid passage to drain the condensate water may be passages formed in four directions (front, rear, left, or right). In this case, each fluid passage may be formed such that the Z axis becomes the lowest direction, when the body of the fuel cell system is tilted as the flying object having the fuel cell system is tilted while moving.

The fuel cut-off valve (FCV) may be disposed on the air supply line linking the fuel cell stack 10 to the AHF, to block hydrogen drained from the AHF from being supplied to the cathode of the fuel cell stack 10, or to adjust the pressure of air supplied to the cathode of the fuel cell stack 10. The fuel cut-off valve may be controlled to be open in a start-On state of the fuel cell system, and controlled to be closed in a start-Off state of the fuel cell system.

In addition, the ACV may be connected to the second drain line linking the fuel cell stack 10 to the AHF. The ACV may block the supply of air drained from the cathode of the fuel cell stack 10 to the AHF through the second drain line, or may adjust the pressure of the air drained from the cathode of the fuel cell stack 10 to the AHF.

Although FIG. 1 illustrates that the ACV is interposed between the air supply line and the second drain line, a first ACV (not illustrated) provided on the air supply line and a second ACV (not illustrated) provided on the second drain line may be implemented while being separated from each other.

In the process of re-circulating hydrogen, which is not reacted at the anode of the fuel cell stack 10, the moisture existing in the hydrogen supply line may be condensed. In this case, the condensate water may be drained through the first drain line linking a point on the hydrogen supply line to transfer, to the FEJ, the non-reacted hydrogen at the anode of the fuel cell stack 10, with the AHF.

A fuel water trap (FWT) and a fuel drain valve (FDV) may be disposed on a first drain line.

The FWT may serve to store the condensate water introduced through the first drain line from the one point of the hydrogen supply line. A low water-level sensor to sense the low level and a high water-level sensor to sense the high level of the condensate water stored in the FWT may be provided at one side of the FWT.

The FDV may serve to drain the condensate water, which is stored in the FWT, to the AHF along the first drain line. In this case, the FDV is closed until the water level of the condensate water stored in the FWT exceeds a specific water level. When the water level of the condensate water stored in the FWT exceeds the specific water level, the FDV may be controlled to be open such that the condensate water is drained along the first drain line.

According to an embodiment, the open state and the closed state of the FDV may be controlled at a specific period regardless of the water level of the condensate water stored in the FWT. For example, the FDV opens the valve in every five seconds to drain the condensate water stored in the FWT.

In addition, a bypass valve-upper (BV_U) provided at the side of an inlet of the FWT and a bypass valve_lower (BV_L) provided at the side of an outlet of the FDV may be additional provided on the first drain line. In this case, the BV_U and the BV_L may be connected to each other through a by-pass line.

The BV_U may be a 3-way control valves. The BV_U may allow the condensate water drained from the anode of the fully cell stack 10 to flow through the FWT or the by-pass line For example, a first port of the BV_U may be connected to the anode of the fuel cell system, a second port of the BV_U may be connected to an inlet of the FWT, and a third port of the BV_U may be connected to a by-pass line.

When the BV_U is closed, the third port of the BV_U connected to the by-pass line is closed, the first port of the BV_U connected to the anode and the second port connected to the FWT are open, such that the condensate water drained from the anode passes through the first port and the second port of the BV_U and move to the FWT.

Meanwhile, when the BV_U is open, the second port of the BV_U connected to the FWT is closed, the first port of the BV_U connected to the anode and the third port of the BV_U connected to the by-pass line are open, such that the condensate water drained from the anode passes through the first port and the third port of the BV_U and is drained to the outside along the by-pass line.

The BV_L may be a 3-way control valve. The BV_L may be drained the condensate water after the FDV or condensate water introduced along the by-pass line may be drained. For example, the first port of the BV_L may be connected to the outlet of the FDV, the second port of the BV_L may be connected to the by-pass line, and the third port of the BV_L may be connected to the AHF connected to an external drain port.

When the BV_L is open, the second port of the BV_L connected to the by-pass line is closed, the first port of the BV_L connected to the FDV and the third port of the BV_L connected to the AHF are open, such that the condensate water passing through the FDV passes through the first port and the third port of the BV_L and is drained to the outside through the AHF.

When the BV_L is closed, the first port of the BV_L connected to the FDV is closed, the second port of the BV_L connected to the by-pass line and the third port of the BV_L connected to the AHF are open, such that the condensate water introduced along the by-pass line is drained to the outside through the AHF after passing through the second port and the third port of the BV_L.

In this case, the open and the closing operation the FDV, the BV_U, and the BV_L may be controlled by the controller.

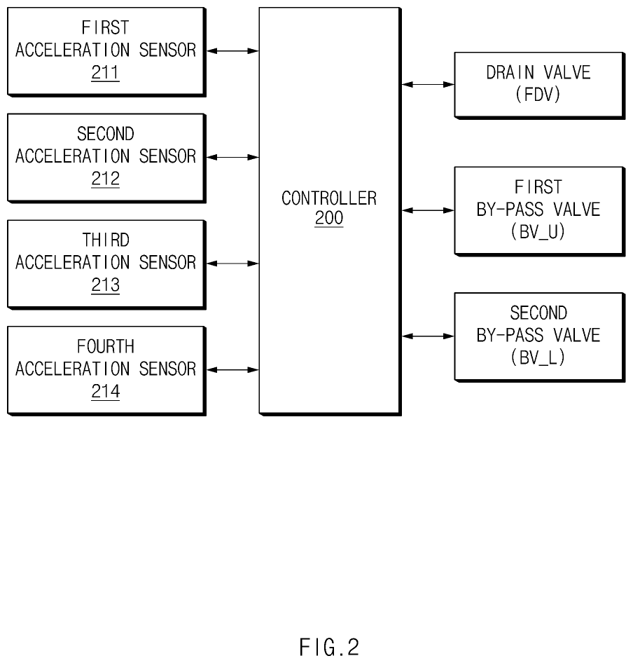

FIG. 2 is a view illustrating a control structure of a fuel cell system, according to an embodiment of the present disclosure.

Referring to FIG. 2, the fuel cell system may include a plurality of acceleration sensors 211 to 214 and a controller 200. The plurality of acceleration sensors 211 to 214 may be provided at mutually different positions of a body constituting the fuel cell system. In this case, the fuel cell system may be implemented in the form of a power pack formed by packaging the modules constituting the fuel cell system, and the acceleration sensors 211 TO 214 may be provided at the external housing of the power pack.

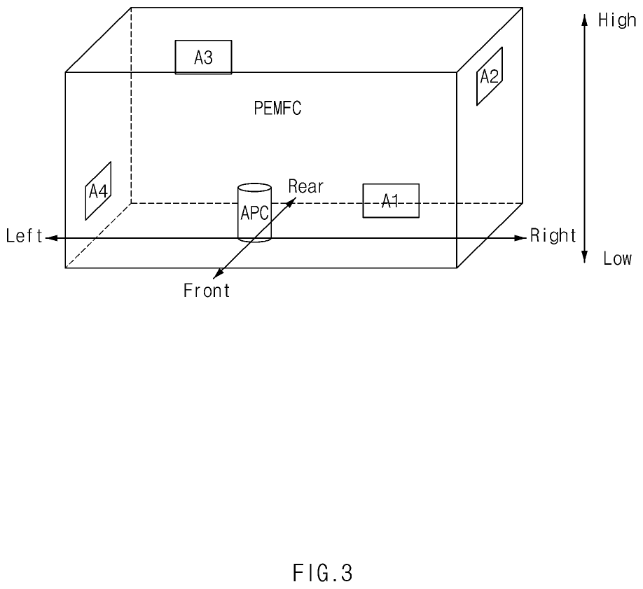

The acceleration sensors 211 to 214 may include the first acceleration sensor 211, the second acceleration sensor 212, the third acceleration sensor 213, and the fourth acceleration sensor 213. On the assumption that the body of the fuel cell system is a rectangular parallelepiped, the first to fourth acceleration sensors 211 to 214 may be provided a front surface, a right surface, a rear surface, and a left surface of the body of the fuel cell system. Placement positions of the acceleration sensors 211 to 214 may be understood by making reference to an embodiment of FIG. 3.

Referring to FIG. 3, the first acceleration sensor 211 may be provided a right-lower portion of a front surface of the body of the fuel cell system, and the second acceleration sensor 212 may be provided at a right-higher portion of a rear surface of the body of the fuel cell system. In addition, the third acceleration sensor 213 may be provided at a left-higher portion of the rear surface of the body, and the fourth acceleration sensor 214 may be provided at a front-lower portion of a left surface of the body.

In addition, as illustrated in FIG. 3. an embodiment of the present disclosure is provided only for the illustrative purpose, but the present disclosure is not limited thereto. The placement positions of the first to fourth acceleration sensors 211 to 214 may be varied depending on the form of an embodiment.

The controller 200 may be a hardware device, such as a processor or a central processing unit (CPU), or a program implemented by the processor. The controller 200 may be connected to each component of the fuel cell system to perform an overall function related to the management and the operation of the fuel cell stack 10. For example, the controller 200 may be a fuel-cell control unit (FCU) to control the overall functions of the fuel cell system.

The controller 200 controls hydrogen supply, water supply, and a drain operation of the fuel cell system. The controller 200 may control the opening operation and the closing operation of the valve provided on the hydrogen supply line, the water supply line, and the drain line to maintain the concentration of hydrogen in the fuel cell stack 10.

The controller 200 may determine the water level of the condensate water stored in the FWT to determine whether to drain the condensate water, and may control the opening and closing operation of the FDV depending on the determination, when the condensate water for hydrogen remaining after reaction in the anode of the fuel cell stack 10 is stored in the FWT.

Meanwhile, the controller 200 may control the opening/closing operation of the FDV, depending on a tilting state of the body of the fuel cell system.

In this case, the controller 200 may seta reference position based on a measurement value measured by the first acceleration sensor 211, and may determine acceleration values for the X axis, the Y axis, and the Z axis, based on the measurement values measured by the second to fourth acceleration sensors 212 to 214 to estimate positions and to estimate the tilting state of the body of the fuel cell system. In this case, the controller 200 may estimate the tilt, that is, the tilting angle and the tilting speed of the body of the fuel cell system. For example, the controller 200 may check a tilting variation based on an acceleration value (ax,y) on the X and Y axes, and may estimate the tilting direction by using a value (vx,y) obtained by integrating the acceleration values (vx,y) on the X and Y axes.

Accordingly, the controller 200 may control the opening operation and the closing operation of the FDV based on the tilting angle and the speed of the body of the fuel cell system and the output of the fuel cell stack 10.

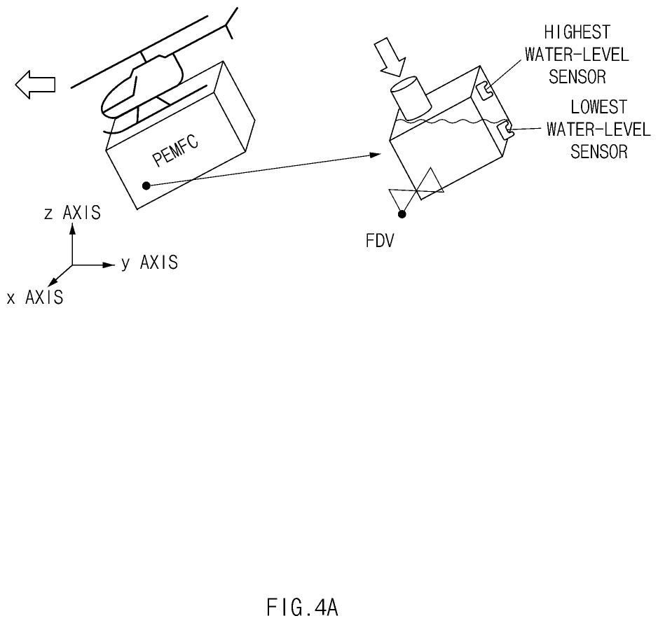

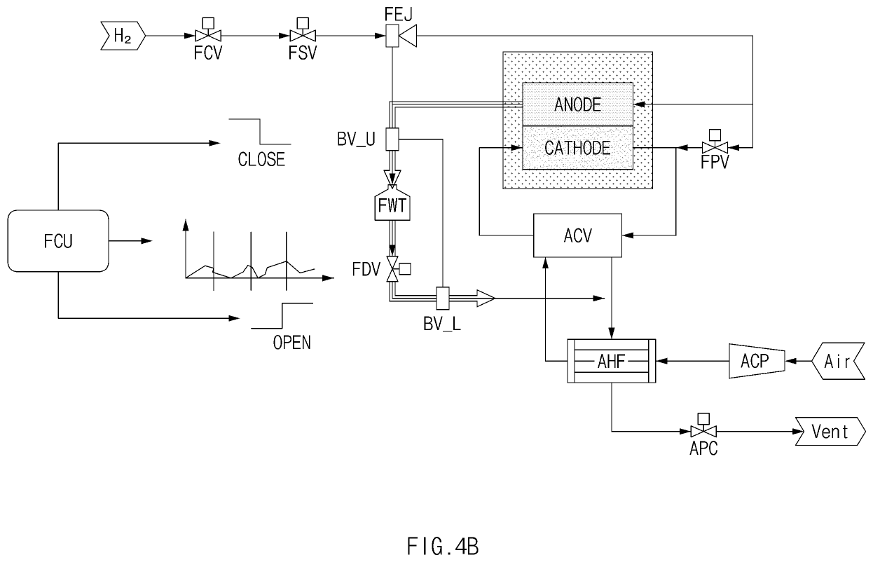

The flying object may not move while maintaining a level state. Accordingly, as illustrated in FIG. 4A, a tilt related to three axes (the X axis, the Y axis, and the Z axis) is formed when the flying object is moved. In this case, when the FWT is tilted such that the condensate water stored in the FWT is titled, the water-level sensor may not exactly sense the water level of the condensate water.

Accordingly, the controller 200 controls the opening/closing operation of the FDV at a specific period, when the tilting angle or the flying speed of the body of the fuel cell system measured by the first to fourth acceleration sensors 211 to 214 exceeds a reference value. Hereinafter, an operation of controlling to drain condensate water will be described with reference to FIG. 4B depending on the tilting state of the body of the fuel cell system.

Referring to FIG. 4B, the controller 200 may close the BV_U in ordinary times (when a by-pass event to the by-pass line does not occur), open the BV_L, and control the opening and closing operation of the FDV, based on the water level of the condensate water stored in the FWT. However, when the flying object is moved, and when the tilting of a specific angle or more and the flying speed are sensed in the three-axis direction, the controller 200 controls the opening and closing operation of the FDV at every specific period instead of the water level of the condensate water.

In this case, the controller 200 opens the FDV every at the specific period regardless of the water level of the condensate water, such that the condensate water stored in the FWT is drained at a specific time interval. When the tilting angle and the speed of the body of the fuel cell system is less than a reference value, the controller 200 controls the opening operation and the closing operation of the FDV, based on the water level of the condensate water stored in the FWT.

Meanwhile, the controller 200 may control the opening operation and the closing operation of the BV_U and the BV_L provided on the first drain line, based on the atmospheric pressure and the external temperature.

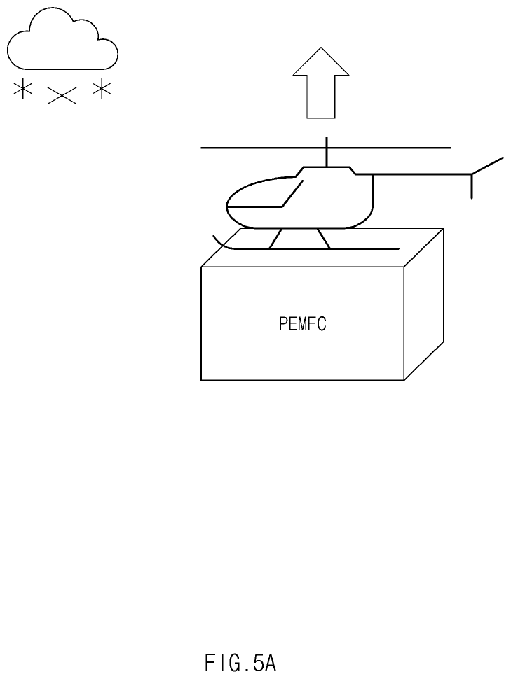

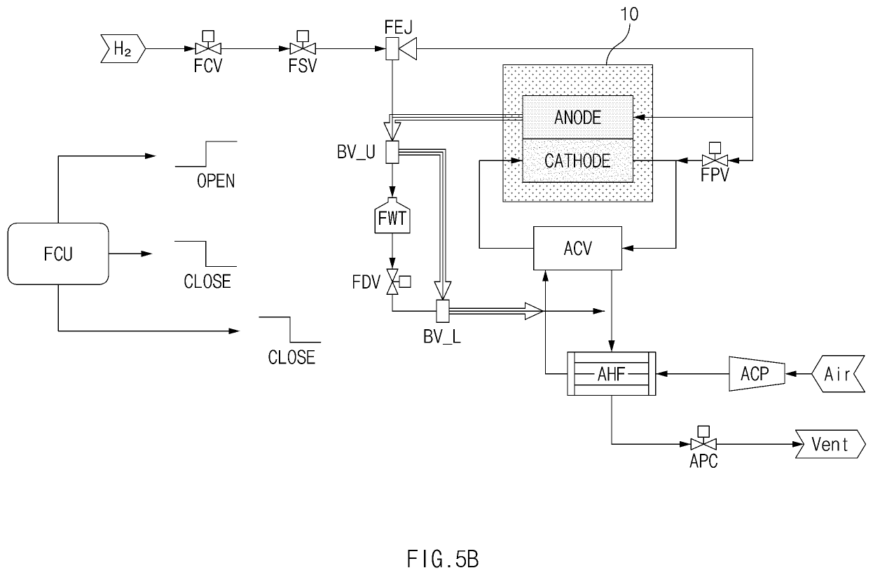

As illustrated in FIG. 5A, as the height of the flying object is increased, the atmospheric pressure is decreased, and the temperature is dropped. In addition, the condensate water stored in the FWT may be frozen in the low external temperature in winter. To this end, the controller 200 determines the by-pass event to the by-pass line as being caused, when the atmospheric pressure is equal to or less than specific atmospheric pressure during the operation of the fuel cell system, and when the external temperature is equal to or less than a specific temperature. Accordingly, an operation of by-passing a flowing path of the condensate water will be described with reference to FIG. 5B.

Referring to FIG. 5B, the controller 200 controls the BV_U to be open, controls the BV_L to be closed, and controls the FDV to be closed, when the atmospheric pressure is equal to or less than specific atmospheric pressure, and when the external temperature is equal to or less than a specific temperature during the operation of the fuel cell system.

For example, when the atmospheric pressure is equal to or less than 0.7, and when the external temperature is equal to or less than zero, the controller 200 may open the BV_U, closes the BV_L, and may close the FDV. In this case, the condensate water drained from the anode into the fuel cell stack 10 is moved to the AHF through the by-pass line, instead of being stored in the FWT. However, since the condensate water stored in the FTW has to be drained in advance, the controller 200 may control the FDV to be open until the water level of the condensate water reaches the low level, and may close the FDV when the low water-level sensor provided in the FWT senses that the water level of the condensate water stored in the FWT reaches the low level.

Hereinafter, the operation flow of the fuel cell system having the above configuration will be described in more detail according to the present disclosure.

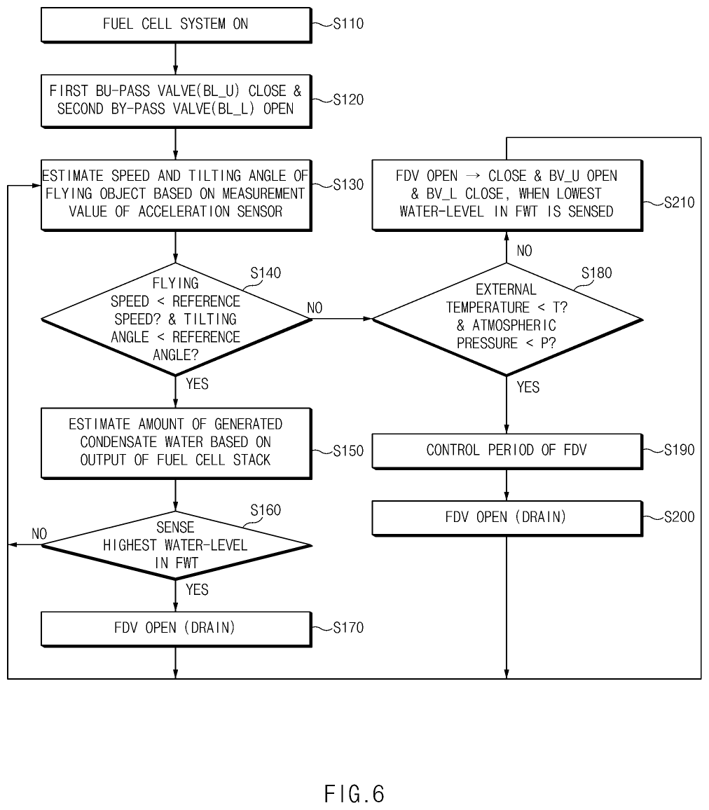

FIG. 6 is a flowchart illustrating the operation in a method of draining condensate water in a fuel cell system, according to an embodiment of the present disclosure.

Referring to FIG. 6, when the fuel cell system is turned on (S110), the fuel cell system closes the BV_U and opens the BV_L (S120). In this case, as the condensate water drained from the anode of the fuel cell stack 10 flows along the first drain line and is stored in the FWT.

In this case, the fuel cell system estimates the speed of the flying object and a tilting angle of the flying object, based on the measurement value measured by the acceleration sensors 211 to 214, that is, the first acceleration sensor A1, the second acceleration sensor A2, the third acceleration sensor A3, and the fourth acceleration sensor A4 provided in a power net of the fuel cell system (S130). In S130, the controller 200 may check a tilting variation based on an acceleration value (ax,y) on the X and Y axes, and may estimate the tilting direction by using a value (vx,y) obtained by integrating the acceleration values (vx,y) on the X and Y axes.

When the speed of the flying object, which is estimated in S130, is less than a reference speed and the tilting angle is less than the tilting angle (S140), the fuel cell system controls the FDV based on the water level of the FWT (S150 to S170). In this case, the fuel cell system estimates an amount of condensate water produced by calculating the output of the fuel cell stack 10 (S150). When the high water-level sensor provided in the FWT senses that the water-level of the condensate water reaches the high level (S160), the fuel cell system opens the FDV and drains the condensate water stored in the FWT (S170).

Meanwhile, when the speed of the flying object is equal to or less than the reference speed, or when the tilting angle is equal to or less than the reference angle in S140, the fuel cell system determines an external temperature and atmospheric pressure. In this case, when the external temperature exceeds the reference temperature (T}, for example, zero, or when the atmospheric temperature exceeds reference pressure (P), for example, 0.7 Pa (S180), the fuel cell system controls the opening or the closing of the FDV at a specific period (S190 and S200). For example, the fuel cell system may drain the condensate water stored in the FWT by opening the FDV at every five seconds.

When the external temperature is equal to or less than the reference temperature (T}, for example, zero, and when the atmospheric pressure is equal to or less than the reference pressure (P), for example, 0.7 Pa in S180, the fuel cell system opens the BV_U and closes the BV_L (S210). In this case, the condensate water drained from the anode of the fuel cell stack 10 flows along the by-pass line and is drained to the outside.

When there is present condensate water stored in the FWT, the fuel cell system may control the FDV to be open until the water level of the condensate water stored in the FWT reaches the lowest-water level, and control the FDV to be closed when the low water-level sensor provided in the FWT senses that the water-level of the condensate water stored in the FWT reaches the low level in S210.

As described above, according to the present disclosure, in the fuel cell system and the method for draining the condensate water thereof, to prevent condensate water from being drained as the flying object is maintained tilted during moving, a condition of controlling the drain valve is changed to a period from a water level, thereby smoothly draining the condensate water regardless of a tilting situation. In addition, when the external temperature and atmospheric pressure are dropped, the condensate water is drained through the by-pass line, thereby preventing the condensate water from being frozen, such that the safety and the system efficiency are increased.

According to an embodiment, the safety of the fuel cell system may be improved by draining the condensate water at a specific period by changing a drain condition of the condensate water stored in the water trap, when the flying object having the fuel cell system is tilted while being moving, and a method for draining the condensate water thereof.

According to an embodiment, a tilting angle and a speed of a flying object may be exactly measured, based on a measurement value measured by acceleration sensors, as the plurality of acceleration sensors are provided at mutually different positions of a body of the fuel cell system, and a method for draining condensate water thereof.

According to an embodiment, condensate water may be drained through a by-pass line bypassing a water trap depending on an external temperature and atmospheric pressure, to prevent the efficiency of the fuel cell system from being degraded due to the condensate water stored in the water trap and frozen, and a method for draining the condensate water thereof.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A fuel cell system, comprising:
a drain valve configured to adjust an amount of condensate water being drained, at an outlet of a water trap having the condensate water drained from an anode of a fuel cell stack; and
a controller configured to:
control the drain valve to be open or closed, based on a water level of the condensate water stored in the water trap; and
control the drain valve to be open or closed at a specific period, when a body of the fuel cell system is tilted.

2. The fuel cell system of claim 1, further comprising:
a plurality of acceleration sensors provided at different positions of the body of the fuel cell system.

3. The fuel cell system of claim 2, wherein the controller is further configured to:
determine a tilting state of the body of the fuel cell system, based on measurement values measured by one or more of the plurality of acceleration sensors.

4. The fuel cell system of claim 2, wherein the plurality of acceleration sensors comprises:
a first acceleration sensor provided on a front surface of the body of the fuel cell system;
a second acceleration sensor provided on a right surface of the body of the fuel cell system;
a third acceleration sensor provided on a rear surface of the body of the fuel cell system; and
a fourth acceleration sensor provided on a left surface of the body of the fuel cell system.

5. The fuel cell system of claim 4, wherein the controller is further configured to:
estimate a tilting angle and a flying speed of the body of the fuel cell system by defining a reference position based on a measurement value measured by the first acceleration sensor; and
determining acceleration values for an X axis, a Y axis, and a Z axis based on respective measurement values measured by the second to fourth acceleration sensors.

6. The fuel cell system of claim 5, wherein the controller is further configured to:
control an opening operation and a closing operation of the drain valve at the specific period, when the tilting angle or the flying speed is equal to or greater than a reference value.

7. The fuel cell system of claim 1, wherein the controller is further configured to:
switch a drain path of the condensate water to a by-pass line, based on one or more of an external temperature and an atmospheric pressure.

8. The fuel cell system of claim 7, further comprising:
a first by-pass valve provided at an inlet of the water trap to by-pass, to a by-pass line, a flowing path of the condensate water flowing into the water trap; and
a second by-pass valve connected to an outlet of the drain valve and the by-pass line to determine a drain path of the condensate water.

9. The fuel cell system of claim 8, wherein the controller is further configured to:
open the first by-pass valve and close the second by-pass valve to switch the drain path of the condensate water to the by-pass line, when the external temperature is equal to or less than a specific temperature and when the atmospheric pressure is equal to or less than specific atmospheric pressure.

10. The fuel cell system of claim 9, wherein the controller is further configured to:
open the drain valve until a water level of condensate water stored in the water trap reaches a preset low level, before the drain path of the condensate water is switched to the by-pass line; and
close the drain valve when the water level of the condensate water reaches the preset low level.

11. The fuel cell system of claim 8, wherein the controller is further configured to:
close the first by-pass valve and open the second by-pass valve when the condensate water is drained to the water trap.

12. A method for draining condensate water of a fuel cell system, the method comprising:
controlling a drain valve, which is provided at an outlet of a water trap, to be open or closed, based on a water level of the condensate water stored in the water trap having the condensate water drained from an anode of a fuel cell stack; and
controlling the drain valve to be open or closed at a specific period of time when a body of the fuel cell system is tilted.

13. The method of claim 12, further comprising:
determining a tilting state of the body of the fuel cell system, based on measurement values measured by a plurality of acceleration sensors provided at different positions of the body of the fuel cell system.

14. The method of claim 13, wherein the determining of the tilting state of the body of the fuel cell system comprises:
estimating a tilting angle and a flying speed of the body of the fuel cell system by defining a reference position based on a measurement value measured by a first acceleration sensor; and
determining acceleration values for an X axis, a Y axis, and a Z axis based on measurement values measured by second, third, and fourth acceleration sensors.

15. The method of claim 14, wherein the controlling of the drain valve to be open or closed at the specific period includes:
controlling an opening operation and a closing operation of the drain valve at the specific period, when the tilting angle or the flying speed is equal to or greater than a reference value.

16. The method of claim 14, wherein the first acceleration sensor is provided on a front surface of the body of the fuel cell system, and
wherein the second, third, and fourth acceleration sensors are respectively provided on a right surface, a rear surface, and a left surface of the body of the fuel cell system.

17. The method of claim 12, further comprising:
switching a drain path of the condensate water to a by-pass line based on an external temperature and atmospheric pressure.

18. The method of claim 17, wherein the switching into the by-pass line comprises:
opening a first by-pass valve, the first by-pass valve being provided at an inlet of the water trap to by-pass, to a by-pass line, to cause a flowing path of the condensate water flowing into the water trap; and
closing a second by-pass valve, the second by-pass valve being connected to an outlet of the drain valve and the by-pass line to establish a drain path of the condensate water when the external temperature is equal to or less than a specific temperature, and when the atmospheric pressure is equal to or less than specific atmospheric pressure.

19. The method of claim 18, further comprising:
opening the drain valve until a water level of condensate water stored in the water trap reaches preset low level, before switching to the by-pass line; and
closing the drain valve when the water level of the condensate water reaches the low level.

20. The method of claim 18, further comprising:
closing the first by-pass valve and opening the second by-pass valve, such that the condensate water is drained to the water trap before switching to the by-pass line.
